(19) United States
(12) Patent Application Publication
(10) Pub. No.: US 2007/0152933 A1
(43) Pub. Date: Jul. 5, 2007

(54) DRIVING DEVICE FOR LIQUID CRYSTAL DISPLAY

(76) Inventors: Seung-Bin Moon, Seoul (KR); Bo-Young An, Suwon-si (KR)

Correspondence Address: David W. Heid;MacPHERSON KWOK CHEN & HEID LLP, Suite 226, 1762 Technology Drive, San Jose, CA, 95110, US

(21) Appl. No.: 11/539,388

(22) Filed: Oct. 6, 2006

(30) Foreign Application Priority Data
Nov. 24, 2005 (KR) 10-2005-0112765

(51) Int. Cl. G09G 3/36

(52) U.S. Cl. 345/89

(57) ABSTRACT

The present invention relates to a driving device for a liquid crystal display includes a gray voltage generator that generates first and second reference gray voltages, a common voltage generator that generates a common voltage, and a data driver that generates a data voltage on the basis of the first and second reference gray voltages and applies the data voltage to the pixels. The gray voltage generator includes a variable resistor unit that changes the first reference gray voltage according to the type of liquid crystal display. In this way, it is possible to manufacture a general-purpose IC capable of being applied to all types of liquid crystal displays, rather than a dedicated IC used for only a specific type of liquid crystal displays.

### CROSS-REFERENCE TO RELATED APPLICATION

This application claims priority to and the benefit of Korean Patent Application No. 10-2005-0112765 filed in the Korean Intellectual Property Office on Nov. 24, 2005, the entire contents of which are incorporated herein by reference.

### FIELD OF THE INVENTION

The present invention relates to a driving device for a liquid crystal display.

### DESCRIPTION OF THE RELATED ART

In general, a liquid crystal display (LCD) includes a display panel having pixel electrodes, a common electrode panel and a liquid crystal layer with dielectric anisotropy interposed between the two panels. The pixel electrodes are arranged in a matrix, and are connected to switching elements such as thin film transistors (TFTs). Data voltages are sequentially applied to rows of pixel electrodes. The common electrode is formed on the entire surface of one of the panels, and a common voltage is applied to the common electrode. The pixel electrode, the common electrode, and the liquid crystal layer interposed therebetween form a liquid crystal capacitor at the pixel unit.

In the liquid crystal display, when a voltage is applied to the two electrodes, an electric field is generated in the liquid crystal layer. The intensity of the electric field is adjusted to control the transmittance of light passing through the liquid crystal layer, thereby obtaining a desired image. However, if the electric field is applied to the liquid crystal layer in one direction for too long time the crystal layer is adversely affected. Therefore, in order to prevent damage, the polarity of a data voltage with respect to the common voltage is inverted for every frame, every column, or every pixel.

Liquid crystal displays can be classified according to modes in which the liquid crystal molecules are arranged. A twisted nematic (TN) mode liquid crystal display is most usual. In order to improve a viewing angle, for example, an in-plane switching (IPS) mode liquid crystal display and a vertically aligned (VA) mode liquid crystal display have also been developed.

The liquid crystal molecules operate in different ranges according to the modes. For this reason, a gray voltage for determining a data voltage applied to the liquid crystal is different according to the modes. For example, the liquid crystal molecules in the twisted nematic mode operate in the range 0.7 V to 3.5 V, and the liquid crystal molecules in the vertical alignment (VA) mode operate in the range of 1.7 V to 4.5 V.

### SUMMARY OF THE INVENTION

A driving device for a liquid crystal display which is capable of providing a gray voltage to liquid crystal displays of various modes in addition to the vertical alignment (VA) mode liquid crystal display. According to an exemplary embodiment of the present invention, a driving device for a liquid crystal display including a plurality of pixels includes a gray voltage generator that generates first and second reference gray voltages, a common voltage generator that generates a common voltage, and a data driver that generates a data voltage on the basis of the first and second reference gray voltages and applies the data voltage to the pixels. The gray voltage generator includes a variable resistor unit that changes the first reference gray voltage according to the type of liquid crystal display. The gray voltage generator may includes first and second resistor column groups that are connected in parallel to each other between a first voltage terminal and a second voltage terminal, and a plurality of muliplexers that are connected to a plurality of resistor columns of each of the first and second resistor column groups.

### BRIEF DESCRIPTION OF THE DRAWING

The foregoing objects and other features of the present invention may become more apparent from a reading of the ensuing description, together with the drawing, in which:

FIG. 1 is a schematic diagram showing a liquid crystal display according to an exemplary embodiment of the present invention.

FIG. 2 is a block diagram schematically showing an SoC (System on Chip) of FIG. 1.

FIG. 3 is a block diagram showing a liquid crystal display according to an exemplary embodiment of the present invention.

FIG. 4 is an equivalent circuit diagram of one pixel in a liquid crystal display according an exemplary embodiment of the present invention.

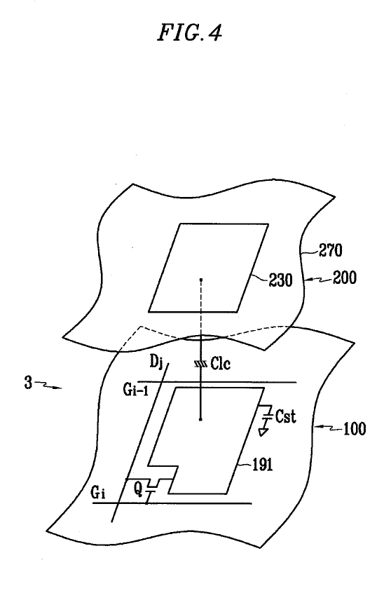

FIG. 5 is a circuit diagram showing an example of a gray voltage generator of a liquid crystal display according to an exemplary embodiment of the present invention.

FIG. 6A and FIG. 6B are views showing a portion of the gray voltage generator of FIG. 5 in detail.

FIG. 7 is a graph showing the relationship between a gray-scale level and a voltage.

FIG. 8 is a view illustrating a method of driving a liquid crystal display according to an exemplary embodiment of the present invention.

### DETAILED DESCRIPTION OF THE EMBODIMENTS

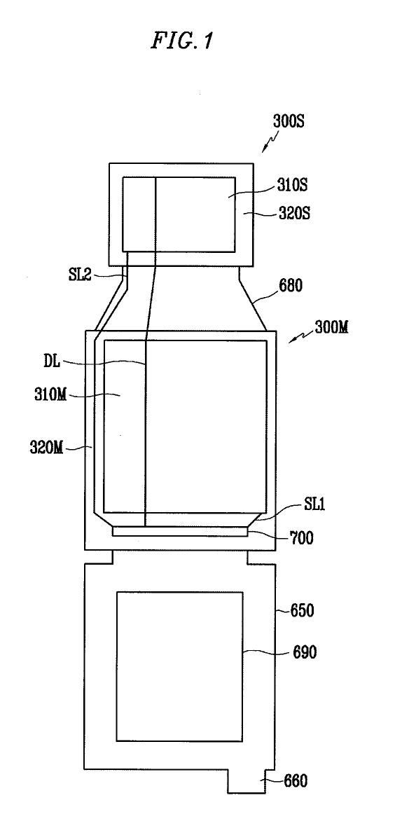

Referring to FIG. 1, a liquid crystal display according to an exemplary embodiment of the present invention includes a main display panel 300M, a sub-display panel 300S, an FPC (flexible printed circuit film) 650 attached to the main display panel 300M, an auxiliary FPC 680 attached to the main display panel 300M and the sub-display panel 300S, and an SoC (System on Chip) 700 mounted on the main display panel 300M.

Although not particularly mentioned below, “400”, “400M”, and “400S” will all be used as reference numerals of a gate driver, and “500”, “501”, and “502 ” will all be used as reference numerals of a data driver.

FPC 650 is attached to one side of main display panel 300M. FPC 650 has an opening 690 where a portion of the sub-display panel 300S is exposed when FPC 650 is bent in an assembly process. On the lower side of opening 690, FPC 650 includes an input section 660 to which an external signal is input, and a plurality of signal lines (not shown) for electrically connecting input section 660 to 700 and SoC 700 to main display panel 300M. The signal lines have large widths at points where the signal lines are connected to SoC 700 and at points where the signal lines are connected to the main display panel 300M so as to form pads (not shown).

Auxiliary FPC 680 is attached to main display panel 300M and one side of sub-display panel 300S. FPC 680 has a plurality of signal lines SL2 and DL for electrically connecting the SoC 700 and the sub-display panel 300S.

Main display panel 300M includes a display area 310M and a peripheral area 320M which has a light-shielding layer (not shown) (also called a “black matrix”). Sub-display panel 300S includes a display area 310S and a peripheral area 320S which has a light-shielding layer (not shown) (also called a “black matrix”). Display areas 310M and 310S form a screen. FPC 650 and the auxiliary FPC 680 are attached to the light-shielding regions 320M and 320S, respectively.

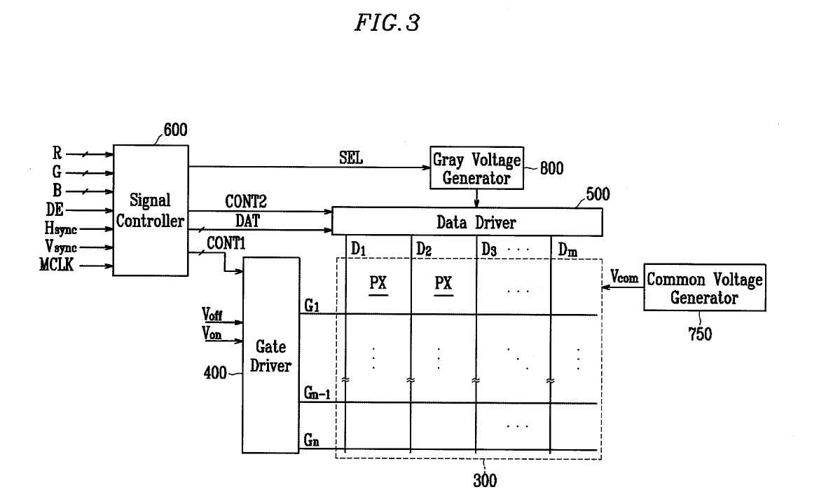

As shown in FIG. 3, the main and sub-display panels 300M and 300S each include a plurality of gate lines G₁ to Gₙ and a plurality of data lines D₁ to Dₘ. A plurality of pixels PX are arranged substantially in a matrix at the intersections of the gate lines and data lines. Most of the pixels PX and the display signal lines G₁ to Gₙ and D₁ to Dₘ are positioned in the display areas 310M and 310S.

Further, as shown in FIG. 1, some of the data lines D₁ to Dₘ of the main display panel 300M are connected to the sub-display panel 300S through the auxiliary FPC 680. In other words, an example in which the main and sub-display panels 300M and 300S share some of the data lines D₁ to Dₘ is shown in FIG. 1, and one of the shared data lines is indicated by DL in FIG. 1.

An upper panel 200 is smaller than a lower panel 100. Therefore, a portion of the lower panel 100 protrudes from the upper panel 200. The data lines D₁ to Dₘ extend to the portion so as to be connected to the data driver 500.

The plurality of gate lines G₁ to Gₙ serve to transmit gate signals (referred to as “scanning signals”), and the plurality of data lines D₁ to Dₘ serve to transmit data signals. Gate lines G₁ to Gₙ extend substantially in a row direction and in parallel with one another. Data lines D₁ to Dₘ extend substantially in a column direction and in parallel with one another. Lines G₁ to Gₙ and D₁ to Dₘ have large widths at the points where they are connected to FPC 650 and the auxiliary FPC 680 so as to form pads (not shown). The main and sub-display panels 300M and 300S are attached to FPC 650 and the auxiliary FPC 680 by an anisotropically conductive layer (not shown) for electrically connecting the pads.

Each pixel PX, for example a pixel PX connected to an i-th (i=1, 2, . . . , n) gate line Gᵢ and a j-th (=1, 2, . . . , m) data line Dⱼ, includes a switching element Q connected to the signal lines Gᵢ and Dⱼ, and a liquid crystal capacitor Clc and a storage capacitor Cst that are connected to the switching element Q. The storage capacitor Cst may be omitted, if necessary.

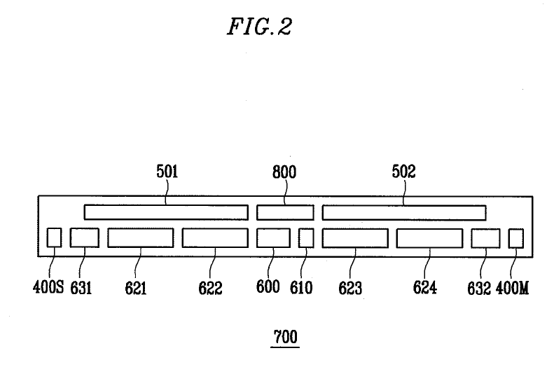

In liquid crystal capacitor Clc, the pixel electrode 191 of the lower panel 100 and the common electrode 270 of the upper panel 200 serve as two terminals, and the liquid crystal layer 3 interposed between the pixel electrode 191 and the common electrode 270 servers as the dielectric material. Pixel electrode 191 is connected to switching element Q, and the common electrode 270 is formed on the entire surface of the upper panel 200 and is supplied with a common voltage Vcom. Unlike the structure shown in FIG. 2, the common electrode 270 may be provided on the lower panel 100. In this case, at least one of the two electrodes 191 and 270 may be formed in a linear or bar shape.

Storage capacitor Cst, serving as an auxiliary member of the liquid crystal capacitor Clc, is composed of a signal line (not shown) provided on lower panel 100, pixel electrode 191, and an insulator interposed therebetween. A predetermined voltage, such as the common voltage Vcom, is applied to the signal line. Alternatively, the storage capacitor Cst may be formed in a laminated structure of the pixel electrode 191, the insulator, and a previous gate line formed on the insulator.

In order to provide a color display, each pixel PX specifically displays one of the primary colors (spatial division), or the pixels PX alternately may display the primary colors over time (temporal division), which causes the primary colors to be spatially or temporally synthesized, thereby displaying a desired color. The primary colors may be composed of, for example, red, green, and blue. As an example of the spatial division, FIG. 2 shows that each pixel PX has a color filter 230 for displaying one of the primary colors in a region of the upper panel 200 corresponding to the pixel electrode 191. Unlikely the structure shown in FIG. 2, the color filter 230 may be provided above or below the pixel electrode 191 of the lower panel 100.

At least one polarizer (not shown) for polarizing light is mounted on an outer surface of a display crystal panel assembly 300.

A gray voltage generator 800, FIG. 3, generates two gray voltage groups (or reference gray voltage groups) related to the transmittance of the pixel PX. One of the gray voltage groups has a positive value with respect to the common voltage Vcom, and the other gray voltage group has a negative value with respect to the common voltage Vcom.

Gate driver 400, 400M, or 400S is connected to gate lines G₁ to Gₙ, and supplies gate signals each of which is composed of a combination of a gate-on voltage Von and a gate-off voltage Voff, to gate lines G₁ to Gₙ. The gate-on voltage Von turns on switching element Q and the gate-off voltage Voff turns off the switching element. Gate driver 400, 400M, or 400S is built in the SoC 700, and supplies the gate signals to the main and sub-display panels 300M and 300S through signal lines SL1 and SL2. Alternatively, gate driver 400, 400M, or 400S may be mounted on the display panel by a CoG (Chip on Glass) technique, or it may be formed in the same process as that in which the switching element Q of the pixel is formed.

Gray voltage generator 800 generates one or two gray voltage groups related to the luminance of the pixel. When the gray voltage generator 800 generates two gray voltage groups, one of the two gray voltage groups has a positive value with respect to the common voltage Vcom, and the other gray voltage group has a negative value with respect to the common voltage Vcom.

Data driver 500 is connected to data lines D₁ to Dₘ of the liquid crystal panel assembly 300, selects the gray voltage generated by the gray voltage generator 800, and supplies the selected gray voltage to the pixels as a data signal.

A signal controller 600 controls the operation of the gate driver 400 and the data driver 500.

SoC 700 receives an external signal through the input section 660 and the signal lines of FPC 650, processes the signal, and supplies the processed signal to main display panel 300M and sub-display panel 300S. SoC 700 includes an oscillator 610, a plurality of memories 621, 622, 623, and 624, and common voltage generators 631 and 632, as well as the gray voltage generator 800, the gate drivers 400M and 400S, the data drivers 501 and 502, and signal controller 600, as shown in FIG. 2. Oscillator 610 provides a reference clock necessary for the operation of various driving signals. The memories 621 to 624 store image signals supplied from the outside. Common voltage generators 631 and 632 generate and supply the generated common voltage Vcom to main display panel 300M and sub-display panel 300S, respectively. Common voltage generators 631 and 632 may also generate power necessary for the operation of other driving circuits.

Now, the display operation of the liquid crystal display will be described in more detail. Signal controller 600 receives input image signals R, G, and B and input control signals for displaying the input image signals from a graphics controller (not shown). For example, any of the following signals may be used as the input control signal: a vertical synchronization signal Vsync, a horizontal synchronization signal Hsync, a main clock signal MCLK, and a data enable signal DE.

Signal controller 600 processes the input image signals R, G, and B so as to be suitable for the requirements of liquid crystal panel assembly 300 as determined by the input control signal and generates, for example, a gate control signal CONT1 and a data control signal CONT2. Then, signal controller 600 transmits the gate control signal CONT1 to gate driver 400, and transmits the data control signal CONT2 and the processed image signal DAT to data driver 500. Signal controller 600 also generates a selection signal SEL and transmits selection signal SEL to gray voltage generator 800.

Gate control signal CONT1 includes a scanning start signal STV for indicating the start of scanning and at least one clock signal for controlling the output cycle of the gate-on voltage Von. Gate control signal CONT1 may further include an output enable signal OE for defining the duration of the gate-on voltage Von. The type of liquid crystal display determines whether the selection signal SEL is output or not.

Data control signal CONT2 includes a horizontal synchronization start signal STH for indicating that start of transmission of data to a row (group) of pixels PX, a load signal LOAD for allowing data signals to be transmitted to the data lines D₁ to Dₘ, and a data clock signal HCLK. The data control signal CONT2 may further include an inversion signal RVS for inverting the polarity of a data signal voltage with respect to the common voltage Vcom (hereinafter, “the polarity of the data signal voltage with reference to the common voltage” is simply referred to as “the polarity of the data signal”).

Data driver 500 receives the digital image signal DAT for a row (group) of pixels PX in response to the data control signal CONT2 transmitted from signal controller 600, selects a gray voltage corresponding to each digital image signal DAT, converts the digital image signal DAT into an analog data signal, and supplies the analog data signal to the corresponding data lines D₁ to Dₘ.

Gate driver 400 applies the gate-on voltage Von to the gate lines G₁ to Gₙ on the basis of the gate control signal CONT1 from signal controller 600 to turn on the switching elements Q connected to the gate lines G₁ to Gₙ. Then, the data signals applied to data lines D₁ to Dₘ are supplied to the corresponding pixels PX through the switching elements Q which are in an ON state.

The difference between the voltage of the data signal applied to the pixel PX and the common voltage Vcom is the charging voltage of liquid crystal capacitor Clc, that is, the pixel voltage. The alignment directions of the liquid crystal molecules depend on the level of the pixel voltage, which causes the polarization of the liquid crystal layer 3 to vary. The variation in polarization causes a variation in the transmittance of light to the polarizer mounted on the liquid crystal panel assembly 300.

These processes are repeatedly performed for every one horizontal period (which is referred to as “1H” and is equal to one period of the horizontal synchronization signal Hsync and the data enable signal DE). In this way, the gate-on voltage Von is sequentially applied to all the gate lines G₁ to Gₙ, and the data signals are supplied to all the pixels PX, thereby displaying one frame of images.

When one frame has ended, the next frame starts. In this case, the state of the inversion signal RVS applied to the data driver 500 is controlled such that the polarity of the data signal applied to each pixel PX is opposite to the polarity of the data signal in the previous frame (“frame inversion”). The polarity of the data signal applied to one data line may be inverted in the same frame according to the characteristics of the inversion signal RVS (for example, row inversion and dot inversion), and the polarities of the data signals applied to a row of pixels may be different from each other (for example, column inversion and dot inversion).

Now, the construction and the operation of the gray voltage generator according to an exemplary embodiment of the present invention will be described in more detail with reference to the accompanying drawings.

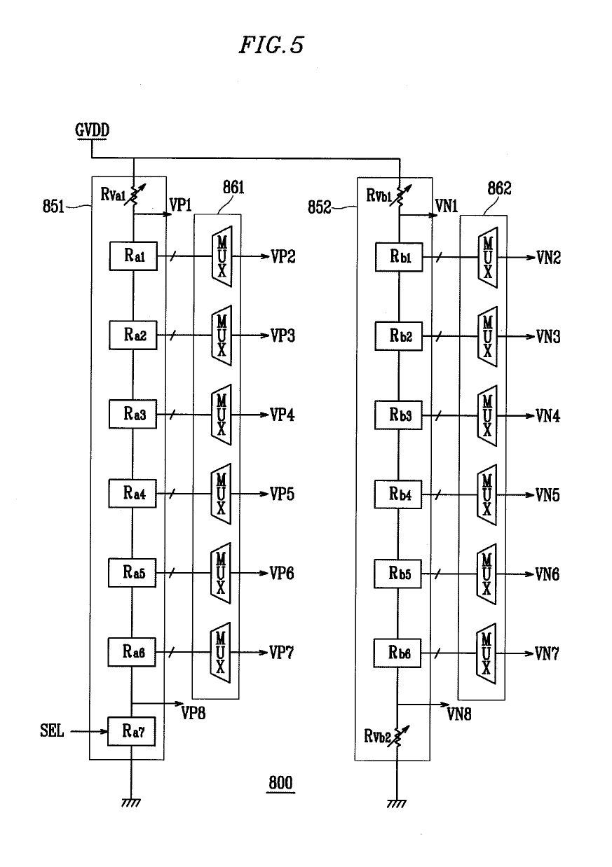

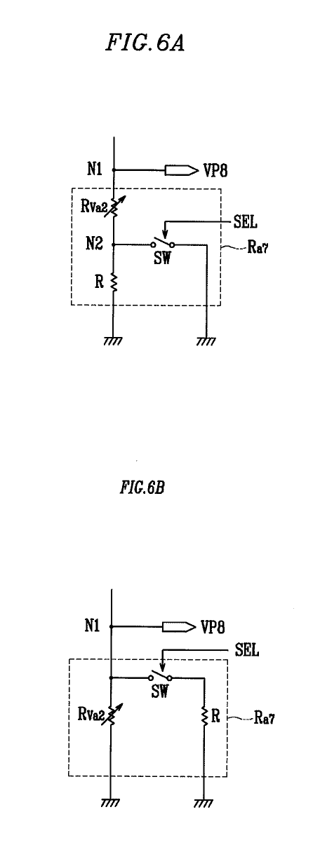

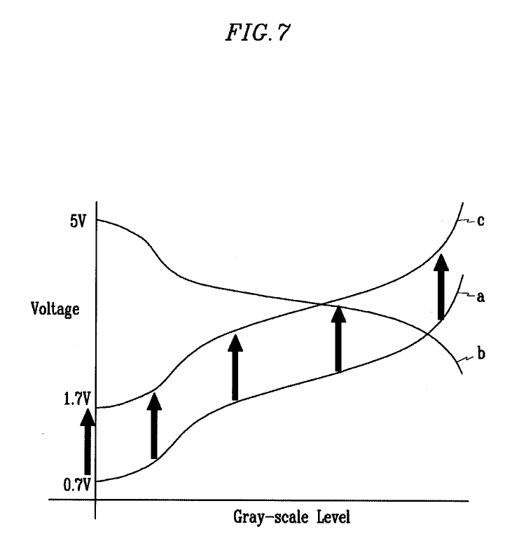

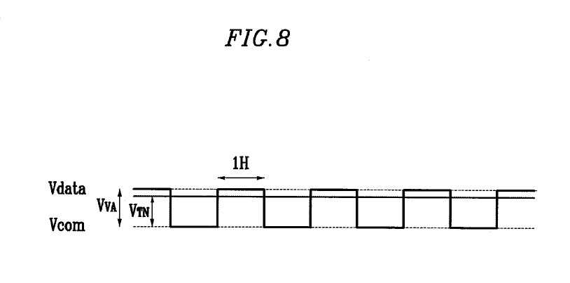

FIG. 5 is a circuit diagram of an example of a gray voltage generator of a liquid crystal display according to an exemplary embodiment of the present invention. FIG. 6A and FIG. 6B are views showing a portion of the gray voltage generator of FIG. 5 in detail. FIG. 7 is a graph showing the relationship between a gray-scale level and a voltage, and FIG. 8 is a view illustrating an inversion method of a liquid crystal display according to an exemplary embodiment of the present invention.

Referring to FIG. 5, gray voltage generator 800 of the liquid crystal display according to an exemplary embodiment of the present invention includes a plurality of resistor column groups 851 and 852 connected between a power supply voltage GVDD and the ground in parallel to each other, and a plurality of selecting units 861 and 862 that are connected to the plurality of resistor column groups, respectively, and each have a plurality of multiplexers (referred to as MUXs).

The resistor column group 851 includes a variable resistor Rvₐ₁, and a plurality of resistor columns Rₐ₁ to Rₐ₇ that are connected in series to one another and are also connected in series to the variable resistor Rvₐ₁. Each of the resistor columns Rₐ₁ to Rₐ₇ is composed of a plurality of resistors. The resistor column group 852 includes a variable resistor Rv_{b1}, a plurality of resistor columns R_{b1}, to R_{b6}, and a variable resistor Rv_{b2} that are connected in series. Each of the resistor columns R_{b1} to R_{b6} is composed of a plurality of resistors.

The resistor column group 851 generates a plurality of reference gray voltages VP1 to VP8 each having a positive polarity, and the resistor column group 852 generates a plurality of reference gray voltages VN1 to VN8 each having a negative polarity.

The resistor column group 851 has substantially the same construction as the resistor column group 852. However, the last stage of the resistor column group 851 is the resistor column Rₐ₇, and the last stage of the resistor column group 852 is the variable resistor Rv_{b2}.

The selecting units 861 and 862 selectively output the voltages generated by the individual resistor columns Rₐ₁ to Rₐ₆ and R_{b1} to R_{b6} each composed of a plurality of resistors.

FIG. 6A and FIG. 6B are two views of the circuit that includes resistor Rₐ₇ of the resistor column group 851 in detail.

Referring to FIG. 6A, switching element SW is connected between ground and a contact point N2 located between the series connected variable resistor Rvₐ₂ and a resistor R that is connected to ground. The switching element SW is operated by the selection signal SEL. A reference gray voltage VP8 is taken from contact point N1 at the end of variable resistor Rᵥₐ₂ remote from contact point N2.

The two resistors Rvₐ₂ and R determine the reference gray voltage VP8. When the reference gray voltage VP8 is determined, the other reference gray voltages VP1 to VP7 increase or decrease in proportion to the reference gray voltage VP8. When the switching element SW is turned off (open-circuited), the two resistors Rvₐ₂ and R are connected in series with each other. When the switching element SW is turned on, the voltage of the contact point N2 is changed to the ground voltage. Therefore, the reference gray voltage VP8 is determined by only the resistor Rvₐ₂. As a result, the reference gray voltage VP8 increases when the switching element SW is turned off, and decreases when the switching element SW is turned on.

The reference gray voltages VP1 to VP8 are assumed to have been adjusted for a twisted-nematic-mode liquid crystal display. However, when the separate resistor R can be prepared and the connection between the two resistors Rvₐ₂ and R can be controlled by the switching element SW, according to the principles of the present invention, so that the reference gray voltages VP1 to VP8 can be applied to a vertical-alignment-mode liquid crystal display which requires higher reference gray voltages. In general, the operation voltage of the liquid crystal of a twisted-nematic-mode liquid crystal display is from 0.7 V to 3.5 V, and the operation voltage of the liquid crystal of a vertical-alignment-mode liquid crystal display is from 1.7 V to 4.5 V higher than that of the twisted-nematic-mode liquid crystal display by about 1V. Therefore, in the general twisted-nematic-mode liquid crystal display, the switching element SW is turned on to lower the reference gray voltage VP8. In the vertical-alignment-mode liquid crystal display, the switching element SW is turned off to raise the reference gray voltage VP8.

Referring to FIG. 6B, the two resistors Rvₐ₂ and R are connected in parallel to each other between the contact point N1 and the ground, and the switching element SW is connected between the contact point N1 and the resistor R.

As described above with reference to FIG. 6A, the reference gray voltage VP8 is determined by the resistance values of the two resistors Rvₐ₂ and R. However, when the two resistors Rvₐ₂ and R are connected in parallel to each other, the equivalent resistance is lower than the resistance of each of the two resistors Rvₐ₂ and R. Therefore, when the switching element SW is turned on, the reference gray voltage VP8 is lowered, and when the switching element SW is turned off, the reference gray voltage VP8 is raised. Accordingly, when the switching element SW is turned on in the twisted-nematic-mode liquid crystal display exemplified above so as to lower the reference gray voltage VP8, or when the switching element SW is turned off in the vertical-alignment-mode liquid crystal display so as to raise the reference gray voltage VP8, the data voltage varies according to the grayscale level, as shown in the graph of FIG. 7.

In FIG. 7, the curved lines a and c each represent a positive polarity data voltage according to the grayscale level, and the curved line b represents a negative polarity data voltage according to the grayscale level. The curved line c is transposed from the curved line a in the arrow direction. The curved line a represents the voltage applied to the liquid crystal of the twisted-nematic-mode liquid crystal display, and the curved line c represents the voltage applied to the liquid crystal of the vertical-alignment-mode liquid crystal display.

In the exemplary embodiment of the present invention, only the positive polarity reference gray voltage is raised, thereby raising only the positive polarity pixel voltages of the pixel voltages applied to the liquid crystal, as described above with reference to FIG. 7.

This relates to line inversion driving in which the common voltage Vcom and the data voltage Vdata are inverted for every column for every one horizontal period 1H, as shown in FIG. 8. In FIG. 8, the data voltage Vdata is represented by a solid line, and the common voltage Vcom is represented by a dotted line. In FIG. 8, “V_{TN}” and “V_{VA}” represent the pixel voltage of the twisted-nematic-mode liquid crystal display and the pixel voltage of the vertical-alignment-mode liquid crystal display, respectively.

The difference between the two voltages Vdata and Vcom represents a pixel voltage applied to the liquid crystal. In order to raise the pixel voltage, one of the two voltages Vdata and Vcom having a higher voltage is raised. When the pixel voltage has a positive polarity, that is, when the data voltage Vdata is higher than the common voltage Vcom, the data voltage Vdata is raised. On the other hand, when the pixel voltage has a negative voltage, that is, when the common voltage Vcom is higher than the data voltage Vdata, the common voltage Vcom is raised, thereby increasing the voltage difference between the two voltages Vdata and Vcom. As a result, the pixel voltage applied to the liquid crystal is raised. In other words, the common voltage Vcom is raised to increase the negative polarity pixel voltage, thereby making the absolute value of the positive polarity pixel voltage equal to the absolute value of the negative polarity pixel voltage. For example, when the common voltage Vcom is inverted between 0V and 5V in the twisted-nematic-mode liquid crystal display, it should be inverted between 0V and 6V in the vertical-alignment-mode liquid crystal display.

In the above-mentioned embodiments, the twisted-nematic-mode liquid crystal display and the vertical-alignment-mode liquid crystal display are used, but the present invention can be applied to other types of liquid crystal displays, for example a planar driving mode liquid crystal display. Further, when the number of resistors R and the number of switching elements SW are determined considering the operation ranges of liquid crystal of those liquid crystal displays, the present invention can be applied to all those liquid crystal displays.

In this way, it is possible to reduce the manufacturing cost of an integrated circuit IC constituting the gray voltage generator 800. In other words, it is possible to manufacture a general-purpose IC that is capable of being applied to all types of liquid crystal displays, rather than a dedicated IC used for only a specific type of liquid crystal display. Therefore, it is possible to reduce the time and cost required to manufacture a dedicated IC that is suitable for a specific type of liquid crystal display.

Furthermore, adding a resistor R and a switching element SW increases the size of the gray voltage generator 800 by only about several tens of micrometers. Thus, the addition of the resistor R and the switching element SW has little effect on the overall size of the SoC 700.

While this invention has been described in connection with what is presently considered to be practical exemplary embodiments, it is to be understood that the invention is not limited to the disclosed embodiments, but, on the contrary, is intended to cover various modifications and equivalent arrangements that will be apparent to those skilled in the art.

What is claimed is:

1. A driving device for a liquid crystal display including a plurality of pixels, comprising:
a gray voltage generator that generates first and second reference gray voltages;
a common voltage generator that generates a common voltage; and
a data driver that generates a data voltage on the basis of the first and second reference gray voltages and applies the data voltage to the pixels,
wherein the gray voltage generator includes a variable resistor unit that changes the first reference gray voltage according to the type of liquid crystal display.

2. The driving device for a liquid crystal display of claim 1, wherein the gray voltage generator includes:
first and second resistor column groups that are connected in parallel to each other between a first voltage terminal and a second voltage terminal; and
a plurality of muliplexers that are connected to a plurality of resistor columns of each of the first and second resistor column groups.

3. The driving device for a liquid crystal display of claim 2, wherein each of the first and second resistor column groups includes first and second variable resistors and a plurality of resistor columns that are connected in series between the first variable resistor and the second variable resistor, and
a variable resistor unit includes a resistor selectively connected to the second variable resistor of the first resistor column group.

4. The driving device for a liquid crystal display of claim 3, wherein one end of the resistor is connected to the second variable resistor, and the other end of the resistor is connected to a ground.

5. The driving device for a liquid crystal display of claim 4, wherein the variable resistor unit further includes a switching element connected between the ground and a contact point of the second variable resistor and the resistor.

6. The driving device for a liquid crystal display of claim 3, wherein the resistor is connected in parallel to the second variable resistor.

7. The driving device for a liquid crystal display of claim 6, wherein the variable resistor unit further includes a switching element connected between the resistor and the second variable resistor.

8. The driving device for a liquid crystal display of claim 5 or 7, further comprising a signal controller that outputs a selection signal for selecting the switching element.

9. The driving device for a liquid crystal display of claim 8, wherein the common voltage has high periods and low periods, each lasting for the duration of one horizontal scan.

10. The driving device for a liquid crystal display of claim 9, wherein the liquid crystal display is a twisted nematic mode display.

11. The driving device for a liquid crystal display of claim 9, wherein the liquid crystal display is a vertical alignment mode display.

12. The driving device for a liquid crystal display of claim 11, wherein the first resistor column group generates a positive polarity reference gray voltage, and the second resistor column group generates a negative polarity reference gray voltage.

13. The driving device for a liquid crystal display of claim 1, wherein the liquid crystal display further includes a display panel having the pixels formed thereon.

14. The driving device for a liquid crystal display of claim 13, further comprising a driving circuit chip that drives the display panel.

15. The driving device for a liquid crystal display of claim 14, wherein the driving circuit chip includes the gray voltage generator, the common voltage generator, and the data driver.
